(19) United States
(12) Patent Application Publication
(10) Pub. No.: US 2011/0195243 A1
(43) Pub. Date: Aug. 11, 2011

(54) WATERPROOF VAPOR-PERMEABLE MULTILAYER ARTICLE

(75) Inventors: Mario POLEGATO MORETTI, Crocetta del Montello (IT); Antonio FERRARESE, Isola Della Scala (IT); Bruno MATTIONI, Udine (IT)

(73) Assignee: GEOX S.p.A., Localita Biadene (Treviso) (IT)

(21) Appl. No.: 13/091,355

(22) Filed: Apr. 21, 2011

Related U.S. Application Data
(63) Continuation of application No. 10/585,107, filed on Jun. 14, 2007, now abandoned.

(30) Foreign Application Priority Data
Dec. 30, 2003 (IT) PD2003A000314

(51) Int. Cl. B32B 3/26; C08J 7/18

(52) U.S. Cl. 428/315.5; 427/489

(57) ABSTRACT

A waterproof vapor-permeable multilayer article, comprising at least one first layer made of a material that is vapor-permeable and microporous and is at least partially hygroscopic or can assume hygroscopic characteristics over time, and at least one second layer that is waterproof and vapor-permeable.

The present invention relates to a waterproof vapor-permeable multilayer article.

### BACKGROUND OF THE INVENTION

Waterproof vapor-permeable multilayer articles, constituted in practice by a membrane based on polytetrafluoroethylene, are currently known particularly in the field of shoes and clothing.

Such membrane is coupled to the fabrics that compose the item of clothing in order to allow correct permeation of the water vapor that forms due to perspiration released by the body within the environment delimited by the item of clothing.

At the same time, the item of clothing must allow correct waterproofing, with the same goal of keeping the body dry.

The same occurs for shoes: membranes of this type are associated with the upper and with the sole of the shoe; in this regard, it should be noted that most of the perspiration of the foot originates at the interface between the sole of the foot and the sole of the shoe.

Currently known membranes, though having been used now for several years and being unanimously acknowledged as being capable of ensuring correct waterproofing and optimum permeability to water vapor and air, nonetheless have aspects that can be improved.

These membranes are scarcely resistant, and in fact they can tear easily: to give them strength, they are therefore coupled, generally by lamination, to a supporting mesh made of plastic material, which inevitably reduces their permeability to water vapor or air.

In any case, coupling to the mesh is not sufficient to achieve acceptable strength characteristics.

In view of the limited consistency of these membranes, it is evident that such membranes are not capable of being self-supporting.

For this reason, for example in soles, the membrane (which is integrated with the mesh) must be coupled to supports that are capable of supporting it adequately.

Moreover, it should be noted that when, for any particular reason, perspiration condenses inside the environment to be kept dry, which is delimited by said membranes, such perspiration can no longer be expelled, causing an unpleasant “wet” effect.

### SUMMARY OF THE INVENTION

The aim of the present invention is to provide a waterproof vapor-permeable multilayer article that solves the drawbacks noted in known types.

Within this aim, an object of the present invention is to provide a waterproof vapor-permeable multilayer article that is structurally strong.

Another object of the present invention is to provide a waterproof vapor-permeable multilayer article that is particularly permeable to vapor or air.

Another object of the present invention is to provide a waterproof vapor-permeable multilayer article that is capable of being self-supporting.

Another object of the present invention is to provide a waterproof vapor-permeable multilayer article that can be manufactured with known systems and technologies.

This aim and these and other objects of the present invention that will become better apparent hereinafter are achieved by a waterproof vapor-permeable multilayer article, characterized in that it comprises at least one first layer made of a material that is vapor-permeable and microporous and is at least partially hygroscopic or can assume hygroscopic properties over time, and at least one second layer that is waterproof and vapor-permeable.

### BRIEF DESCRIPTION OF THE DRAWINGS

Further characteristics and advantages of the invention will become better apparent from the description of two preferred but not exclusive embodiments thereof, illustrated hereinafter by way of non-limiting example in the accompanying drawing, wherein:

FIG. 1 is a sectional view of a first embodiment of a multilayer article according to the invention;

FIG. 2 is a sectional view of a variation of the multilayer article of FIG. 1;

FIG. 3 is a sectional view of a second embodiment of a multilayer article according to the invention;

FIG. 4 is a sectional view of a variation of the multilayer article of FIG. 3.

### DESCRIPTION OF THE PREFERRED EMBODIMENTS

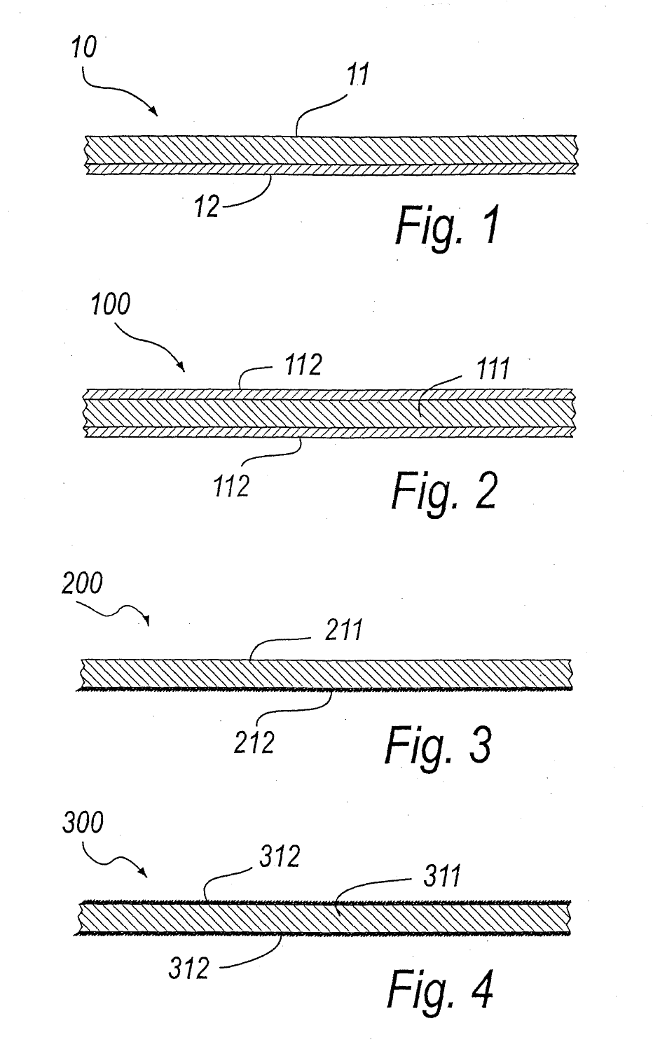

With reference to the first embodiment, shown in FIG. 1, a waterproof vapor-permeable multilayer article according to the invention is generally designated by the reference numeral 10.

The multilayer article 10 comprises a first layer 11, made of a material that is vapor-permeable, microporous and hygroscopic, and a second layer 12, which is waterproof and vapor-permeable.

The first layer 11 is constituted for example by a hygroscopic material based on polyolefin and filler particles.

The filler particles are designed to create the micropores that allow permeability to vapor or air.

The polyolefin that is used in the example being described has a very high molecular weight; for this reason, such polyolefin is preferably a UHMW (ultra high molecular weight) polyethylene.

The characteristics of a UHMW polyolefin are referred to a polyolefin with an average molecular weight of at least 500.000 g/mole.

Preferably, the average molecular weight is comprised between 4×10⁶ g/mole and 7×10⁶ g/mole.

The preferred filler is a finely milled silica (silicon dioxide, SiO₂).

Silica has an important hygroscopic capacity, to the full advantage of the hygroscopic properties of the first layer 11.

The optimum average diameter of the filler particles of silicon dioxide SiO₂ are comprised between 0.01 and 20 μm, while the average surface area of said fillers is comprised between 30 m²/g and 950 m²/g.

Preferably, the average surface area of the filler particles is at least 100 m²/g.

The first layer 11 being described has a pore size of less than 1 μm in diameter.

Preferably, over 50% of the pores have a diameter of less than 0.5 μm.

Porosity understood as:

Porosity=[1−(apparent membrane density/resin density)]×100

is preferably at least 50%.

The first layer 11 is for example treated with antibacterial and/or fungicidal agents.

The preferred final form is a sheet of preset thickness, substantially comprised between 200 μm and 1.5 cm; in particular, between 200 and 600 μm.

A microporous membrane known by the trade-name DARAMIC® and manufactured by DARAMIC Inc. (Norderstedt, Germany) has the characteristics described above for the first layer 11 and therefore can be used to form a multilayer article according to the invention.

Such microporous membrane is per se known and is currently used as a partition in accumulators and batteries and is provided in sheet form.

The characteristics of the membrane are disclosed in U.S. Pat. No. 3,351,495 (in the name of W R GRACE & Co.) and U.S. Pat. No. 6,139,759 (in the name of Daramic Inc.).

The version with a thickness of 600 μm of said DARAMIC® membrane has an ultimate tensile strength of substantially 5.8 MPa and a maximum breaking elongation of 505% (according to ISO 37): accordingly, it has excellent strength characteristics.

In this first described embodiment, the second layer 12, which is waterproof and vapor-permeable, is constituted by a hydrophobic microporous material based on polypropylene (where the term “polypropylene” is used to designate any polymer, homopolymer or copolymer originating from propylene monomers).

Preferably, the polypropylene of the second layer 12 is an isotactic homopolymer with low affinity for the absorption of proteins and fats.

A hydrophobic membrane known by the trade-name CELGARD® of the company CELGARD Inc. has the characteristics described above for the second layer 12 and therefore can be used to form a multilayer article according to the invention.

The coupling between the first layer 11 and the second layer 12 occurs depending on the type of “appearance” that said layers have at the time of coupling.

For example, if both the first layer 11 and the second layer 12 are in sheet form, they can be coupled by applying spots of adhesive, so as to avoid creating a compact layer, or by using known high-frequency or ultrasound technologies, avoiding the subtraction of breathable surface.

An alternative is for example to spread or roll one layer onto the other, which is considered as a backing.

In this case, the spread layer must strongly adhere to the underlying backing so as to resist separation.

Moreover, such layer must have the characteristic of being easy to form or place on the underlying layer by means of large-scale spreading and rolling techniques.

The polymeric polyethylene layer of the DARAMIC® membrane can be suitable for spreading, since its molecular weight is high enough to prevent its penetration into the pores of the microporous support, or can be dispersed in aggregates that are larger than the pores of the CELGARD® polypropylene membrane.

For example, one method for producing a multilayer article according to the invention is as follows:

a solution or dispersion of the basic polymeric mix for the first layer 11 in a volatile organic liquid with low surface tension is prepared in order to produce a spreading solution that has a certain viscosity;

the solution is applied by spreading to the surface of the sheet of the second layer 12 that acts as a backing, in order to form a coating layer on its surface;

the volatile components of the spread are made to evaporate in order to promote the cross-linking reaction of the spread surface;

the coating is dried in order to remove the residual humidity to produce the laminated article.

It is evident that one or more additional layers of polymer can be applied likewise and dried in order to reach the intended thicknesses.

The solution of the polymer can be applied to the backing made of hydrophobic microporous membrane by means of standard spreading techniques that are known in the background art, for example roller spreading or spray spreading.

One variation to the basic configuration of the multilayer article 10 composed of two individual layers is shown in FIG. 2.

In this variation, the multilayer article according to the invention, generally designated by the reference numeral 100, is composed of a first layer 111 made of vapor-permeable microporous hygroscopic material, which is delimited in a sandwich-like fashion by two second layers 112 that are waterproof and vapor-permeable.

It is evident that the first layer 111 and the second layers 112 respectively have the same characteristics described earlier for the first layer 11 and the second layer 12.

Moreover, it is evident that other variations may have superimpositions of one or more of said first and second layers, combined according to the requirements.

A second layer 12 (or 112) can also be provided by spreading a fluoropolymer on a first microporous layer 11 (or 111) or optionally a polysiloxane.

For example, such fluoropolymer is the one commercially known by the trade name Zonyl® and manufactured by DuPont.

The second layer 12 (or 112) can also be provided by immersing the first layer 11 (or 111) in a bath of a fluoropolymer (for example Zonyl®) or of a polysiloxane.

A second embodiment (see FIG. 3) of a multilayer article according to the invention, generally designated by the reference numeral 200, has a first layer 211 such as the one described in the above examples and has, as its second layer, designated here by the reference numeral 212, a film obtained by means of a plasma deposition treatment.

The idea of the film by plasma deposition arises from the surprising experimental discovery that a vapor of a siloxane organic compound can be used to produce an ultrathin layer on a microporous backing material by “cold plasma” polymerization in high vacuum at ambient temperature, providing waterproofing characteristics without altering the general characteristics and particularly the permeability characteristics of the backing material.

A waterproof and breathable hydrophobic layer can in fact be provided by plasma polymerization for example of a monomer based on siloxane, by depositing a layer of polymer (polysiloxane) on a microporous backing material (for example made of polyethylene or polystyrene).

This deposition can also be performed for example by using oil-repellent and water-repellent fluoropolymers such as those produced by DuPont and registered with the trade name Zonyl®.

Plasma is divided into hot and cold depending on the temperatures reached; it is also divided into ambient-pressure plasma and vacuum plasma.

In a cold plasma process to obtain a film according to the present invention, a gaseous or vaporized precursor compound is introduced in a reaction chamber at a very low pressure (in vacuum conditions).

A plasma condition is generated by energizing the precursor inside the reaction chamber by generating an electrical field.

The result is an ultrathin layer of the polymer, which adheres to, and is deposited on, the entire surface of any substrate material introduced in the reaction chamber.

The plasma polymerization process is started and performed by means of an electrical field so as to achieve breakdown of the precursor of the deposition layer within the reaction chamber.

Once breakdown has occurred, ions and reactive species are formed which begin and produce the atomic and molecular reactions that ultimately form thin films.

Layers created by plasma polymerization can use various configurations of electrical fields and different reaction parameters.

The thickness of the layer is controlled by selecting the initial polymerizable material and the reaction conditions, such as the deposition time of the monomer, the treatment time, the electrical frequency at which the reaction is performed, and the power used.

In the present invention, plasma polymerization is performed in vacuum.

The typical pressure range is between 10⁻¹ and 10⁻⁵ mbar.

The precursor is made to react in its pure state by using a non-polymerizable inert gas, such as for example argon; such inert gas is used both as an inert dilution agent and as a carrier gas that assists the polymerization of the precursor.

Other gases that can be used are any of oxygen, helium, nitrogen, neon, xenon and ammonia.

The precursor must have a vapor pressure that is sufficient to be able to vaporize in a moderate vacuum.

The plasma deposition process begins by loading the backing material to be coated (in this case, the first layer 212) into the reaction chamber and then bringing the chamber to the intended vacuum pressure.

Once the vacuum pressure has been reached, the plasma polymerization reaction or a pretreatment reaction can begin.

The plasma polymerization reaction occurs by producing the discharge that generates the plasma and by injecting the vaporized precursor monomer into the reaction chamber.

A pretreatment reaction is required when the surface of the first layer is to be cleaned by subjecting it to an inert gas such as argon or nitrogen in order to clean the surface or promote the adhesion of the polymer film.

During the plasma generating discharge, the collision of the monomer with the ions and electrons of the plasma allows polymerization of the monomer.

The resulting polymer is deposited on the exposed surfaces inside the chamber.

The properties of the film are not just a function of the structure of the monomer but also a function of the discharge frequency, of the power used, of the monomer flow-rate and, of the pressure.

Porosity, surface morphology and permeability can vary according to the reaction conditions.

The deposition process ends when the intended thickness of deposited material is reached.

Owing to the fact that the first layer 212 is made of insulating material (polyethylene, for example, is one of the most insulating materials known), in order to maintain the plasma conditions it is necessary to apply to the process a radiofrequency generator in order to make the electrical field in the treatment oscillate with a frequency substantially on the order of 13.56 MHz, with an applied electric field power substantially equal to 50-700 watts and a vacuum level comprised between 10⁻¹ and 10⁻⁵ mbar.

As regards the duration of the treatment, it has been observed that for a precursor such as a siloxane monomer, the optimum time is substantially comprised between 160 and 600 seconds; in particular, an optimum duration of substantially 420 seconds has been identified.

One variation to the basic configuration of the multilayer article 200 composed of two individual layers is shown in FIG. 4.

In this variation, the multilayer article according to the invention, generally designated by the reference numeral 300, is composed of a first layer 311 made of vapor-permeable and hygroscopic microporous material, which is delimited in a sandwich-like fashion by two seconds layers 312, which are waterproof and vapor-permeable.

It is evident that the first layer 311 and the second layers 312 respectively have the same characteristics described earlier for the first layer 211 and the second layer 212.

Moreover, it is evident that other variations may have superimpositions of one or more of the first and second layers, combined according to the requirements.

In practice it has been observed that the invention thus described solves the problems noted in known types of waterproof and vapor-permeable multilayer article.

A multilayer article has in fact been provided which associates a first microporous and hygroscopic layer with a second hydrophobic layer, said layers preventing the inflow of any liquid phase while allowing the transfer of water vapor and other volatile components.

The silicon-based filler provided inside the first layer in order to generate the microporous structure is a highly hygroscopic material that has a great tendency to absorb water: accordingly, the first layer is not appropriate to be used individually as a waterproof layer, but is very useful for conveying perspiration and moisture away from the body (the torso or legs in the case of clothing, the feet in the case of shoes).

Moreover, since the first hygroscopic layer and the second hydrophobic layer are both structurally stronger than the membranes currently used and are thicker, they can be used in combination without backings that reduce their permeability to vapor or air.

In this regard, since the multilayer article (10, 100, 200, 300 et cetera) has structural characteristics, it can be used as a supporting structure of a shoe; for example, in combination with a tread that has upward openings, the multilayer article can be used as a supporting element of a breathable and waterproof sole.

Such layers can be coupled, depending on the requirements, by applying spots of adhesive so as to avoid creating a compact layer or by using known high-frequency or ultrasound technologies, avoiding the subtraction of breathable surface, or by spreading or rolling of one layer onto the other.

In this regard, since the first layer is the one that reaches greater thicknesses without compromising vapor and air permeability, by using it as a backing for the plasma deposition of a waterproof breathable film, it is possible to achieve the same above mentioned aim and objects by pairing the two layers by spreading, rolling or adhesive bonding.

It should be noted that the use of plasma deposition solves the problems of conformity and adhesion of the first layer on the second layer, since the plasma-deposited polymer adheres to the backing layer for a longer time than, for example, a conventional spreading.

Moreover, since the waterproof film is deposited in partial vacuum conditions, and since the backing material can be cleaned in the reaction chamber beforehand with argon with a high degree of purity, any impurities that could generate fractures, discontinuities, distortions of the deposited waterproof film are completely avoided.

The invention thus conceived is susceptible of numerous modifications and variations, all of which are within the scope of the appended claims; all the details may further be replaced with other technically equivalent elements.

In practice, the materials used, so long as they are compatible with the specific use, as well as the dimensions, may be any according to requirements and to the state of the art.

The disclosures in Italian Patent Application No. PD2003A000314 from which this application claims priority are incorporated herein by reference.

1-38. (canceled)

39. A waterproof vapor-permeable multilayer article, comprising:
at least one first layer made of a material that is vapor-permeable and microporous, said first layer material being further selected from a group comprising materials that are at least partially hygroscopic and material that can assume hygroscopic characteristics over time; and
at least one second layer that is waterproof and vapor-permeable and is a plasma deposited ultrathin film of (1) an oil-repellent and water-repellent fluoropolymer or (2) a polysiloxane.

40. The multilayer article according to claim 39, wherein said at least one first layer comprises a base of polyolefin and a filler made of filler particles.

41. The multilayer article according to claim 40, wherein the molecular weight of said polyolefin is at least 500,000 g/mole.

42. The multilayer article according to claim 41, wherein the molecular weight of said polyolefin is between 4×10⁶ g/mole and 7×10⁶ g/mole.

43. The multilayer article according to claim 40, wherein said polyolefin is constituted by a material selected from a group consisting of isotactic polypropylene and polyethylene.

44. The multilayer article according to claim 40, wherein said filler is silicon dioxide SiO₂.

45. The multilayer article according to claim 44, wherein an average diameter of the filler particles of silicon dioxide SiO₂ is substantially between 0.01 μm and 20 μm, while an average surface area of said fillers is substantially between 30 m²/g and 950 m²/g.

46. The multilayer article according to claim 44, wherein an average surface area of said filler particles is at least 100 m²/g.

47. The multilayer article according to claim 39, wherein said at least one first layer made of microporous material has a pore size of less than 1 μm in diameter.

48. The multilayer article according to claim 47, wherein more than 50% of the pores of said at least one first layer made of microporous material have a diameter of less than 0.5 μm.

49. The multilayer article according to claim 48, wherein the porosity of said at least one first layer made of microporous material is at least 50%.

50. The multilayer article according to claim 39, wherein said at least one first layer made of microporous material has a thickness between 200 μm and 1.5 cm.

51. The multilayer article according to claim 50, wherein said at least one first layer made of microporous material has a thickness between 200 μm and 600 μm.

52. The multilayer article according to claim 39, wherein said at least one second layer is a plasma deposited ultrathin film of an oil-repellant and water-repellent fluoropolymer.

53. The multilayer article according to claim 39, wherein said at least one second layer is a plasma deposited ultrathin film of a polysiloxane.

54. The multilayer article as set forth in claim 39, wherein said at least one second layer is a plasma deposited ultrathin film obtained by plasma deposition treatment of a monomer.

55. The multilayer article of claim 54, wherein the plasma deposited ultrathin film is deposited by plasma deposition treatment carried out under high-vacuum cold plasma conditions.

56. The multilayer article of claim 55, wherein said plasma deposition treatment is carried out using a radiofrequency generator so that an electrical field in the treatment oscillates with a frequency substantially between 13 MHz and 14 MHz.

57. The multilayer article according to claim 56, wherein said plasma deposition treatment is carried out by using a radiofrequency generator so that an electrical field in the treatment oscillates with a frequency on the order of 13.56 MHz.

58. The multilayer article of claim 57, wherein the plasma deposition treatment is carried out using a power of the electrical field applied in the treatment that is substantially between 50 watts and 700 watts.

59. The multilayer article of claim 58, wherein the duration of said plasma deposition treatment for a siloxane-based monomer is between 160 and 600 seconds.

60. The multilayer article according to claim 59, wherein the duration of said plasma deposition treatment for a siloxane-based monomer is substantially equal to 420 seconds.

61. The multilayer article according to claim 60, wherein the level of vacuum in said plasma deposition treatment is substantially between 10⁻¹ mbar and 10⁻⁵ mbar.

62. The multilayer article according to claim 54, wherein the plasma deposition treatment is carried out working in high-vacuum cold plasma conditions using a radiofrequency generator so that an electrical field in the treatment oscillates with a frequency on the order of 13.75 MHz, with an applied electrical field power of 300-500 watts, and a vacuum level between 10⁻¹ and 10⁻⁵ mbar.

63. The multilayer article of claim 62, wherein said monomer is a siloxane-based monomer.

64. The multilayer article of claim 62, wherein said at least one second layer is a plasma deposited ultrathin film of a polysiloxane.

65. A method for producing a multilayer article according to claim 64, comprising the steps of:
loading the first layer to be coated into a reaction chamber;
bringing the reaction chamber to a preset vacuum pressure;
starting plasma generating electrical discharge;
injecting vaporized precursor monomer into said reaction chamber; and
waiting for a preset deposition time.

66. A production method according to claim 65, comprising a pretreatment step that consists of the surface cleaning of said first layer by subjecting it to an inert gas that is injected into said reaction chamber.

67. The multilayer article of claim 39, wherein said at least one second layer is a plasma deposited ultrathin film on a microporous backing material.

68. The multilayer article of claim 67, wherein said at least one second layer is a plasma deposited ultrathin film of a polysiloxane on a microporous polyethylene backing material or a microporous polystyrene backing material.

69. The multilayer article of claim 67, wherein said at least one second layer is a plasma deposited ultrathin film of an oil-repellant and water-repellant fluoropolymer on a microporous polyethylene backing material or a microporous polystyrene backing material.
